(19) United States
(12) Patent Application Publication
(10) Pub. No.: US 2001/0027462 A1
(43) Pub. Date: Oct. 4, 2001

(54) Automatic distributed processing system and computer program product

(75) Inventor: Koji Muramatsu, Kawasaki-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 09/817,259

(22) Filed: Mar. 27, 2001

(30) Foreign Application Priority Data
Mar. 28, 2000 (JP) 2000-088703

(51) Int. Cl. G06F 9/00; G06F 9/54; G06F 15/163

(52) U.S. Cl. 709/102

(57) ABSTRACT

The server connected to a client via a network has a relay library which includes an instruction relay thread which appends a thread identifier to an instruction, which is generated during processing of an application, and relays the instruction in collaboration with a higher-level library, and an instruction distribution thread for searching for a thread that processes another instruction from the client. The client has an instruction execution module including an instruction distribution thread for receiving the instruction with the thread identifier, creating a thread that processes the instruction, and passing the instruction to that thread with the thread identifier, and an instruction processing thread for processing the received instruction in collaboration with a higher-level library, and for, when another instruction is generated during the instruction process or the instruction process is complete, sending the other instruction appended with the thread identifier to the instruction distribution thread.

### CROSS-REFERENCE TO RELATED APPLICATIONS

This application is based upon and claims the benefit of priority from the prior Japanese Patent Application No. 2000-088703, filed Mar. 28, 2000, the entire contents of which are incorporated herein by reference.

### BACKGROUND OF THE INVENTION

The present invention relates to an automatic distributed processing system which avoids deadlock caused by distributed processes, and a computer program product.

As shown in FIG. 1, an automatic distributed processing system in which a server 1 and client 3 are connected via a network is known. For example, a process that has an application, a higher-level library, and a lower-level library (e.g., GUI (Graphical User Interface available from a third party), and entrusts only a display process (e.g., a process of a popup window) from the server to the client may be proposed.

In general, an automatic distributed processing system entrusts some of processes to be executed on a standalone machine to another machine to distribute processes. A merit of this system for example, is that an application program need only be installed on the server, but need not be installed on individual client terminals. Even when the specifications of the application have been changed, only the application program of the server need be changed, thus allowing easy maintenance. Furthermore, if the application runs in the form of a web, since the manufacturers and models of clients do not matter, and a server machine and client terminals need not use those available from an identical manufacturer, the system has flexibility.

In such automatic distributed processing system, since processing which is to be done by an independent thread or process is distributed to an entrust source (to be also referred to as a server hereinafter) and an entrust destination (to be also referred to as a client hereinafter), an exclusive function acts to disturb original operation, thus causing so-called deadlock.

Generation of deadlock will be explained below with reference to FIG. 1.

During execution of an application in the server 1, when an instruction relay thread (user thread) 7 generates an instruction to be entrusted to the client 3, that instruction is relayed to the client 3. Therefore, the server 1 waits for completion of the entrusted process in this state, as indicated by the dotted arrow in FIG. 1.

On the other hand, an instruction processing thread 11 of the client 3 receives the instruction entrusted from the server 1, and processes it. When another instruction is generated during processing of this instruction (another instruction is included in the processing of that instruction), and must be entrusted to an instruction processing thread 9 of the server 1 (i.e., that instruction cannot be processed by the client but must be entrusted to the server), the thread 11 sends the other instruction to the server 1. Hence, the client 3 waits for completion of the entrusted process in this state, as indicated by the dotted arrow in FIG. 1. That is, both the server 1 and the client 3 wait for completion of the entrusted processes.

However, since the server 1 that received the other instruction has already been granted an exclusive lock during its own application process and is waiting for completion of the entrusted process, i.e., cannot process the other instruction entrusted from the client 3, deadlock occurs in the server 1. Therefore, neither the server 1 nor client 3 can process the entrusted instructions (deadlock). Of course, in an environment in which locks of all higher- and lower level libraries can be managed, deadlock can be avoided if no lock is granted/held. However, when an application available from a third party runs in an execution environment of a given company, the application generates an instruction while holding a lock, thus causing deadlock.

In order to avoid such deadlock, an exclusive process portion (lock mechanism) may be removed from the instruction processing thread of the client 3. However, the instruction processing thread (e.g., GUI library) of the client 3 cannot be fully exploited. When a lower-level library (e.g., GUI library) is created by a third party, the specifications of the instruction processing thread of the client 3 may be acquired from a machine developer to avoid a lock. However, the specifications cannot always be acquired from the machine developer, and an exclusive function cannot always be completely avoided if they can be acquired.

Even when the server 1 entrusts a given instruction process to the client 3, if that instruction process includes another instruction, the client 3 may entrust the other instruction to the server 1, i.e., instructions are nested. At this time, the thread of the server 1 that executes the other instruction becomes an object to be excluded, and the server 1 cannot make exclusive management.

### BRIEF SUMMARY OF THE INVENTION

It is an object of the present invention to provide an automatic distributed processing system that can reliably avoid deadlock caused by distributed processes, and a computer program product.

In order to achieve the above object, in an automatic distributed processing system according to the present invention, in which server and client machines are connected via a network, the server machine includes an instruction relay library having a table for managing threads on the basis of thread identifiers, a server instruction relay thread for, when an instruction is generated during processing of a server application, appending a thread identifier managed by the table to the instruction, and sending that instruction in collaboration with a server higher-level library, and a server instruction distribution thread for distributing threads which are to process other instructions from the client machine, and the client machine includes an instruction execution module having a client instruction distribution thread for receiving the instruction sent from the server instruction relay thread together with the thread identifier, creating a thread that processes the instruction, and passing the instruction to the thread together with the thread identifier, and an instruction processing thread for processing the received instruction in collaboration with a client higher-level library, and for, when another instruction is generated during processing of the received instruction or that processing is complete, sending the other instruction or a processing end reply appended with the thread identifier to the server instruction distribution thread.

According to the present invention, with the above arrangement, when the application processing of the server machine generates an instruction, its instruction relay thread appends a thread identifier to that instruction, sends the instruction to the instruction distribution thread of the client machine, and waits for reception. The instruction distribution thread which received the instruction and identifier creates an instruction processing thread, and passes the instruction to that thread together with the identifier.

When processing of the received instruction is complete or another new instruction is generated during that processing, the instruction processing thread sends an instruction processing end reply or the other instruction appended with the identifier to a thread distribution thread of the server machine. Since the thread distribution thread of the server machine passes the received reply or instruction to the instruction relay thread as an instruction source on the basis of the identifier, the instruction relay thread shifts from the reception waiting state to a state in which it is ready to process the instruction end reply or the other instruction, deadlock can be easily avoided even when the other instruction is generated. That is, even when the instruction relay thread holds a lock, as the other instruction is included in the instruction that the instruction relay thread entrusted to the client machine, no trouble such as resource lock conflict occurs if the other instruction is executed. Therefore, the other instruction is distributed to the thread which entrusted the instruction processing including the other instruction, thus avoiding deadlock.

Note that a series of processes mentioned above can be implemented even when the client machine generates an instruction, if it has the same arrangement as that of the server machine. In this case, the client machine can have the same arrangement as that of the server machine, and the server machine can have that of the client machine.

Also, when a program that specifies a processing sequence is recorded in advance on a recording medium, the server and client machines can implement a series of processes mentioned above by reading the program.

In an automatic distributed processing system according to the present invention, each of the server and client machines comprises an instruction relay thread for, when an instruction is generated upon processing of a self application after an exclusive lock, acquiring a lock and relaying the instruction to a partner machine, and an instruction processing thread for receiving and processing the instruction from the instruction relay thread, at least the instruction processing thread of the client machine comprises means for receiving the instruction from the server machine, checking if a self machine can acquire a lock, and sending a retry request to the server machine if the lock cannot be acquired, and means for acquiring the lock if the lock can be acquired, and sending a reply upon completion of processing of the instruction, and releasing the lock, and at least the instruction relay thread of the server machine comprises means for making a retry that temporarily releases the lock, then reacquires the lock, and relays the instruction again upon receiving the retry request from the client machine, and means for releasing the lock upon receiving the reply indicating end of the instruction from the server machine.

According to the present invention, with the above arrangement, when the server machine acquires an exclusively lock and sends an instruction to the client machine, the client machine checks whether to acquire a lock or not after the instruction is received, and when the client machine already holds a lock, since no lock can be acquired, the client machine sends a retry request to the server machine.

Upon receiving the message, since the server machine releases the lock, and retries to relay an instruction by reacquiring a lock, deadlock can be easily avoided even when the two machines generate instructions at substantially the same time.

If both the machines have the same arrangement, when either of these machines receives an instruction from the other machine, it can send a retry request or can execute an instruction process by checking if that machine can acquire a lock, thus avoiding generation of deadlock.

When a program that specifies the processing sequence is recorded in advance on a recording medium, the server and client machines can implement a series of processes mentioned above by reading the program.

In an automatic distributed processing system according to the present invention, the server machine comprises: an instruction relay thread which has means for, when a first instruction is generated during processing of an application after an exclusive lock, releasing the lock in correspondence with contents of the instruction, and sending the first instruction to an instruction processing thread of the client machine, and means for ending the first instruction upon receiving an end reply of the instruction process in the instruction processing thread; and an instruction processing thread for processing a second instruction sent from an event processing thread of the client machine, and the client machine comprises: an instruction processing thread of the client machine for, when the first instruction is received from the instruction relay thread, acquiring an exclusive lock, processing the first instruction, releasing the lock, waiting until a restart request is received from the event processing thread, releasing the lock upon completion of the instruction process after the restart, entrusting the end of the instruction process to the instruction relay thread, and sending a restart request to the client machine which is in the wait state; and an event processing thread of the client machine for, when a second instruction is generated during a self event process after an exclusive lock, entrusting the second instruction to the instruction processing thread of the server machine.

According to the present invention, with the above arrangement, since a lock is released depending on instruction contents, e.g., upon receiving a dialog display instruction, and the instruction is relayed to a partner machine, a lock can be acquired and the instruction can be executed upon receiving a dialog process end message from the partner machine.

According to the present invention, deadlock can be prevented while using a processing unit of the client without any modification.

Even when the server machine entrusts a given instruction to the client machine, and a processing unit in the client machine, which is called by that instruction, issues another instruction to the server machine, i.e., even when instructions are nested, deadlock can be prevented in the same manner as a case wherein processes are not distributed. The same applies to a case wherein the client machine entrusts an instruction to the server machine.

Furthermore, even when the server and client machines simultaneously acquire an exclusive lock which a single machine should hold under normal circumstances, exclusion is achieved by only inhibiting/permitting acquisition of the exclusive lock by the client and server machines, thus easily preventing deadlock.

Moreover, even when an instruction is executed in which a process is executed by acquiring an exclusive lock upon normal execution, and after the exclusive lock is released, an instruction source thread waits until a specific instruction is executed, deadlock can be reliably prevented.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view for explaining a mechanism in which deadlock occurs in a conventional system;

FIG. 2 is a diagram showing the arrangement of an automatic distributed processing system according to the first embodiment of the present invention;

FIG. 3 is a schematic diagram showing the arrangement of execution modules upon normal execution of an application;

FIG. 4 is a flow chart showing the operation of the first embodiment shown in FIG. 2;

FIG. 5 is a view for explaining the second example of a mechanism in which deadlock occurs;

FIG. 6 is a diagram showing the arrangement of an automatic distributed processing system for avoiding deadlock shown in FIG. 5 according to the second embodiment of the present invention;

FIG. 7 shows details of a lock management table shown in FIG. 6;

FIG. 8 is a flow chart showing the operation of the second embodiment shown in FIG. 6;

FIG. 9 is a flow chart for explaining the process upon normal execution of an execution machine;

FIG. 10 is a view for explaining the third example of a mechanism in which deadlock occurs; and

FIG. 11 is a flow chart showing the operation of an automatic distributed processing system for avoiding deadlock shown in FIG. 10 according to the third embodiment of the present invention.

### DETAILED DESCRIPTION OF THE INVENTION

Preferred embodiments of the present invention will be described hereinafter with reference to the accompanying drawings.

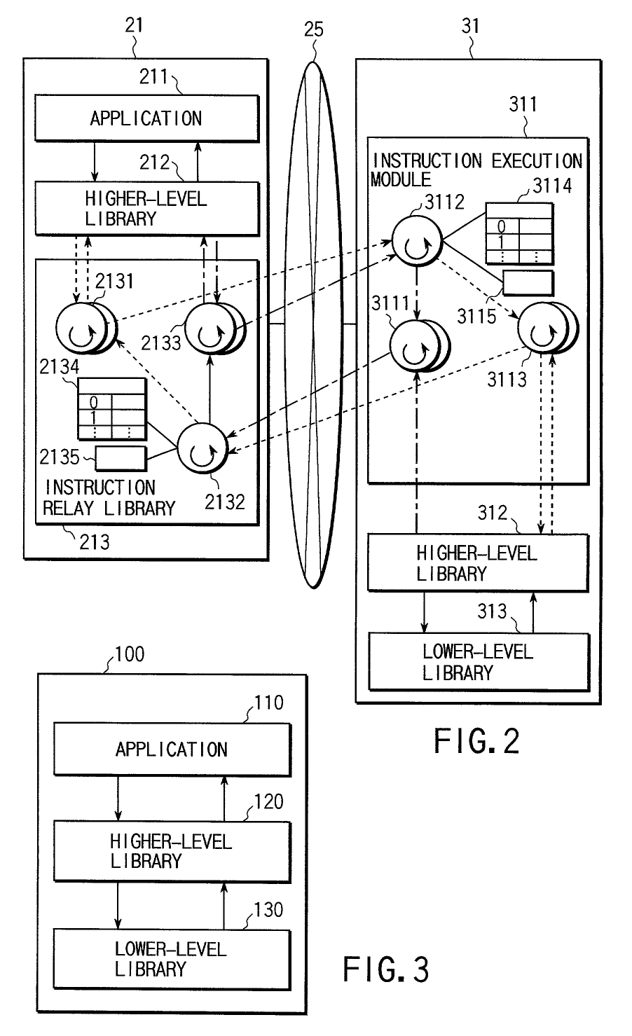

FIG. 2 is a diagram showing the arrangement of an automatic distributed processing system that processes, e.g., a GUI or the like according to the first embodiment of the present invention.

In this system, a server machine 21 which entrusts, e.g., a display process part or the like of the GUI, and a client machine 31 which executes the display process entrusted from the server machine 21, are connected via a network 25.

The server machine 21 is comprised of an application 211 that specifies a series of processes that pertain to the GUI or the like, a higher-level library 212 which runs while linking with the application 211, and an instruction relay library 213 which relays an instruction from the higher-level library 212 to the client machine 31. On the other hand, the client machine 31 is comprised of an instruction execution module 311 which processes an instruction from the instruction relay library 213 of the server 21, a higher-level library 312 which runs while linking with the instruction execution module 311 and is compatible with the server higher-level library 212, and a lower-level library 313 which runs while linking with the higher-level library 312.

The aforementioned application 211, higher-level library 212, and instruction relay library 213 are stored in, e.g., a hard disk device (not shown) of the server 21, and are loaded onto a system memory upon execution as needed. Likewise, the instruction execution module 311, higher-level library 312, and lower-level library 313 are stored in, e.g., a hard disk device of the client machine 31, and are loaded onto a system memory upon execution as needed. Alternatively, these programs may be loaded from a recording medium that records them upon execution. As the recording medium, a CD-ROM, magnetic disk, or the like is normally used. In addition, for example, a magnetic tape, DVD-ROM, floppy disk, MO, CD-R, memory card, or the like may be used.

The instruction relay library 213 of the server machine 21 is compatible with the lower-level library 313 of the client machine 31. More specifically, the library 213 comprises an instruction relay thread 2131 for relaying an instruction from the higher-level library 212 to the instruction execution module 311 of the client 31, an instruction distribution thread 2132 for searching for a thread that is to process an instruction from the instruction execution module 311 of the client 31 and distributing an instruction to the found thread, an instruction processing thread 2133 for passing an instruction from the instruction distribution thread 2132 to the higher-level library 212 to process it, a thread management table 2134 for managing threads using thread identifiers, a released thread storage unit 2135 for managing the instruction processing threads 2133 that have completed their processes and been released, and the like. The released thread is assigned to another instruction entrusted from the client machine 31.

The instruction execution module 311 of the client machine 31 includes an instruction relay thread 3111 for relaying an instruction from the client lower-level library 313 to the instruction relay library 213, a distribution thread 3112 for searching for a thread that is to process an instruction from the instruction relay library 213 of the server 21 and distributing an instruction to the found thread, an instruction processing thread 3113 for passing an instruction from the distribution thread 3112 to the higher-level library 312 to process it, a thread management table 3114 for managing threads using thread identifiers, a released thread storage unit 3115 for managing the destination instruction processing threads 3113 that have completed their processes and been released, and the like.

FIG. 3 is a schematic diagram of modules generally used upon executing an application.

More specifically, an execution machine 100 has an application 110, a higher-level library 120 that runs while linking with the application 110, and a lower-level library 130 which runs while linking with the higher-level library 120, and executes the application 110. In the embodiment of the present invention shown in FIG. 2, upon executing the application 211 that processes, e.g., a GUI or the like, the lower-level library 130 is replaced by the instruction relay library 213 compatible with that lower-level library (existing GUI library) 130 so as to automatically distribute processes.

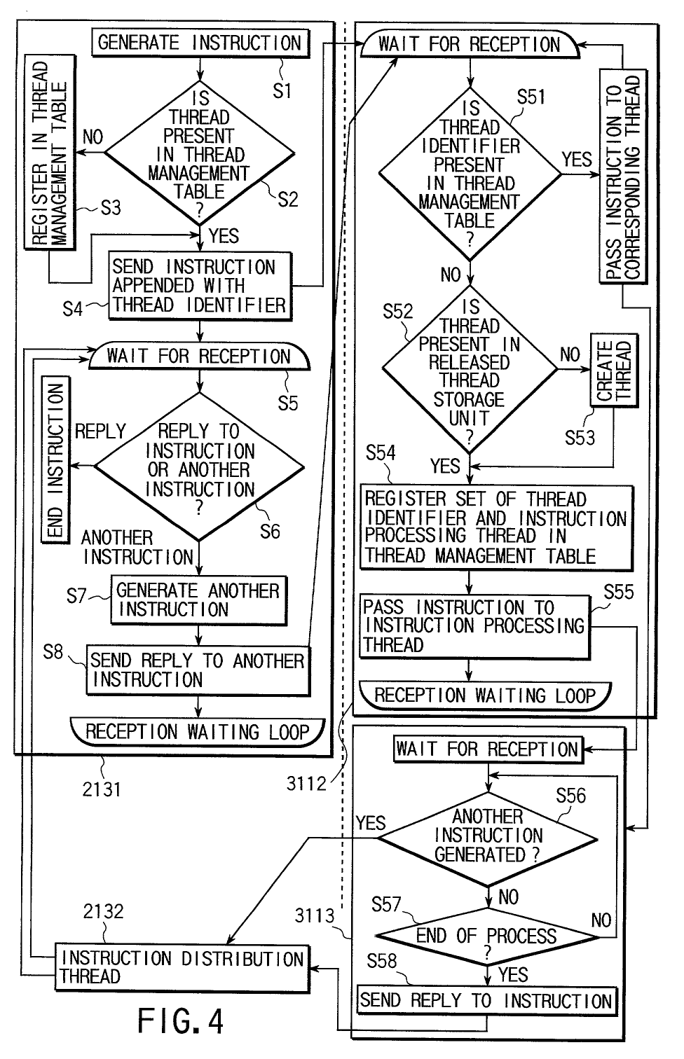

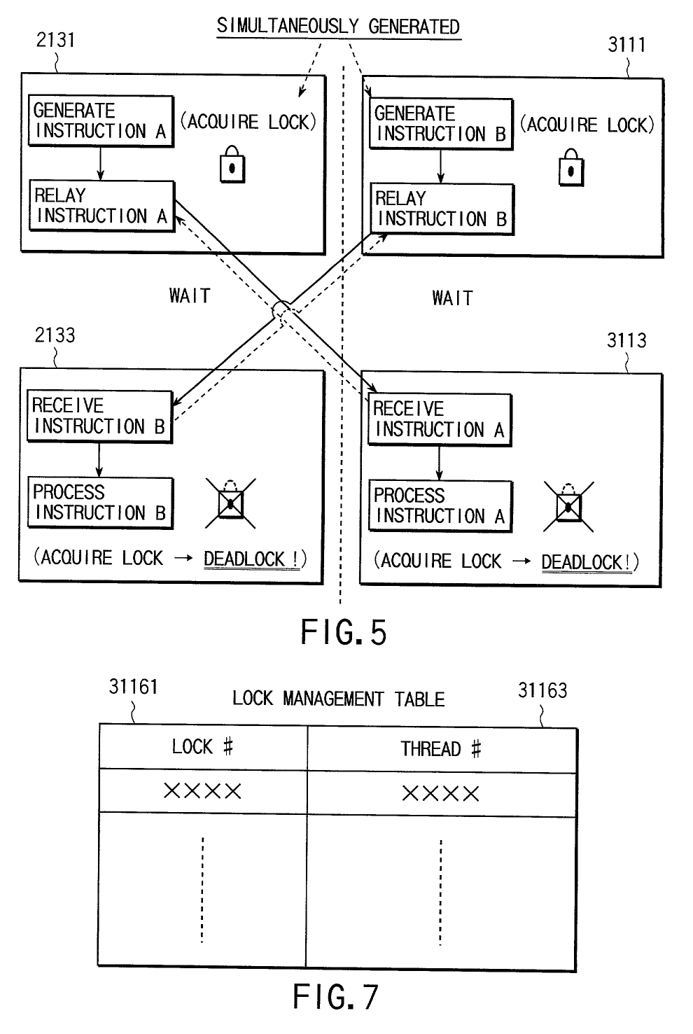

A series of processes especially for preventing deadlock in the aforementioned automatic distributed processing system will be described below with reference to FIG. 4. Note that FIG. 4 does not illustrate the network 25 for the sake of simplicity. Also, since the instruction relay thread 2131 of the server 21 and the instruction relay thread 3111 of the client 31, and the instruction distribution thread 2132 of the server 21 and the instruction distribution thread 3112 of the client 31 respectively execute similar processes, a description of the processing flow of one of these threads will be omitted.

Upon receiving an instruction from the higher-level library 212, the instruction relay library 213 executes the following processes.

If an instruction is generated via the higher-level library 212 upon executing the application 211 in the server machine 21 (S1), the instruction relay thread 2131 such as a user thread or the like checks if an instruction processing thread for that instruction is registered in the thread management table 2134 (S2). If YES in step S2, the flow advances to step S4. On the other hand, if no such thread is registered, the thread 2131 registers the corresponding instruction processing thread in the thread management table 2134 (S3), and the flow advances to step S4. In step S4, the thread 2131 appends a thread identifier of the source to the instruction, relays that instruction to the instruction distribution thread 3112 of the client machine 31, and sets itself in a reception wait state. These steps S1 to S4 specify a function of relaying an instruction.

The instruction distribution thread 3112 of the client machine 31 checks if the thread identifier of the thread that processes the instruction is registered in the thread management table 3114 (S51). If NO in step S51, the thread 3112 checks if a thread is present in the released thread storage unit 3115 (S52). If NO in step S52, the thread 3112 creates a new thread together with the identifier (S53), registers a set of the thread identifier and instruction processing thread in the thread management table 3114 (S54), and then passes the instruction to that instruction processing thread 3113 (S55). If a released thread is found in step S52, the thread 3112 passes the instruction to the instruction processing thread via step S54. These steps S51 to S55 specify a function of creating an instruction processing thread and passing an instruction thereto.

The instruction processing thread 3113 executes a process while linking with the higher-level library 312. In this case, the process may come to an end or another instruction may be generated during the process. Hence, the thread 3113 checks if another instruction is generated (S56). If YES in step S56, the thread 3113 appends to the instruction the aforementioned identifier received from the server machine 21, and sends the instruction to the instruction distribution thread 2132 of the server machine. If no instruction is generated in step S56, the thread 3113 checks while linking with the higher-level library 312 if the processing of that instruction is complete (S57). If YES in step S57, the thread 3113 similarly appends the identifier received from the server machine 21 to a reply indicating completion of the instruction, and sends the reply to the instruction distribution thread 2132 of the server machine 21 (S58).

Upon receiving the other instruction or processing end reply from the client 31 together with the identifier, the instruction distribution thread 2132 of the server machine 21 entrusts the processing to the instruction relay thread 2131 as an entrust source on the basis of the identifier. The instruction relay thread 2131 checks if a reply to the instruction or another instruction is received (S6). If a reply is received, the thread 2131 ends the process; if another instruction is received, the thread 2131 issues another instruction to the higher-level library 212 to process it (S7). Upon completion of the processing of the other instruction, the thread 2131 sends a processing end reply of the other instruction to the instruction distribution thread 3112 of the client machine 31 together with the thread identifier of the source of the client 31 (S8).

Therefore, according to the aforementioned embodiment, deadlock can be easily avoided.

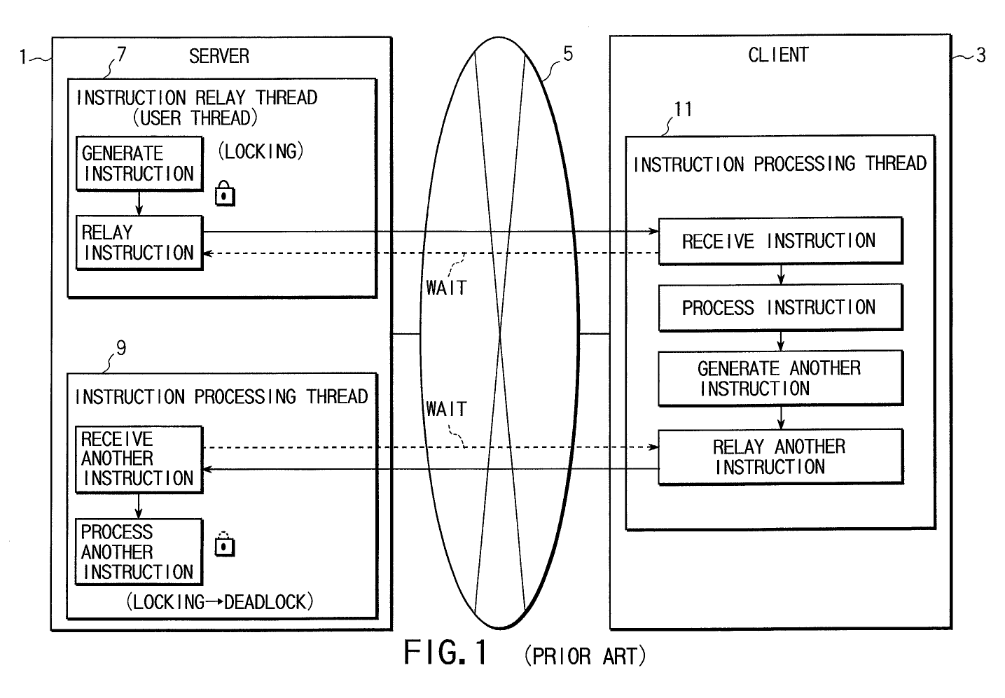

More specifically, when the server machine 21 entrusts a given instruction to the client machine 31, and the client higher-level library 312 called in this instruction entrusts another instruction to the server machine 21, the instructions are nested, as shown in FIG. 1, thus causing deadlock.

However, in this embodiment, when another instruction is generated on the client 31 side, since the thread identifier which has been received when the instruction was entrusted from the server 21 side is returned together with that instruction. Hence, the server 21 can discriminate an entrust source thread. In this case, although the instruction relay thread 2131 as the entrust source holds a lock, since the other instruction is included in the instruction processing entrusted to the client 31, and no resource mismatching occurs even when that instruction is executed, the other instruction can be executed. Therefore, deadlock can be avoided.

FIG. 5 is a view for explaining an example of the deadlock generation mechanism, which is different from FIG. 1. In the example shown in FIG. 5, deadlock takes place in a specific situation even when the processing is entrusted to the client machine while appending a thread identifier to the instruction, as has been explained in the first embodiment shown in FIGS. 2 to 4.

This system is an example of an application in which the instruction relay thread 2131 such as a user thread or the like of the server machine 21, and an event processing thread (instruction relay thread) 3111 of the client machine 31 simultaneously attempt to acquire an identical exclusive lock upon normal execution of an application. For example, in some cases, an application acquires a lock and generates an instruction, and at the same time, an existing GUI library locks an instruction execution module (display module) and generates an instruction.

In such case, when the instruction relay thread 2131 generates instruction A while holding a lock upon processing of the application on the server 21 side, it relays instruction A to the instruction processing thread 3113 of the client machine 31 and sets itself in a processing wait state. On the other hand, when a lower-level library, e.g., an existing GUI library generates an event (instruction B) while holding a lock, the event processing thread 3111 relays instruction B to the instruction processing thread 2133 of the server machine 21 and sets itself in a processing wait state. When these machines 21 and 31 entrust instructions to the partner machines 31 and 21 with a time difference, no problem is posed. However, when both the machines 21 and 31 simultaneously generate instructions, they cannot acquire each other's locks, thus causing deadlock. More specifically, assume that the instruction relay thread (user thread) 2131 acquires lock #1, and the instruction relay thread (event processing thread) 3111 acquires lock #2. The instruction relay thread (user thread) 2131 relays instruction A to the instruction processing thread 3113, and sets itself in a wait state. On the other hand, the instruction relay thread (event processing thread) 3111 relays instruction B to the instruction processing thread 2133, and sets itself in a wait state. In order to process instruction A, the instruction processing thread 3113 attempts to acquire lock #3. However, since lock #2 is already held by the instruction relay thread (event processing thread) 3111, the thread 3113 cannot acquire that lock. Likewise, in order to process instruction B, the instruction processing thread 2133 attempts to acquire lock #1. However, since lock #1 is already held by the instruction relay thread (user thread) 2131, the thread 2133 cannot acquire that lock. For this reason, neither instruction processing threads 2133 and 3113 can acquire locks, resulting in deadlock.

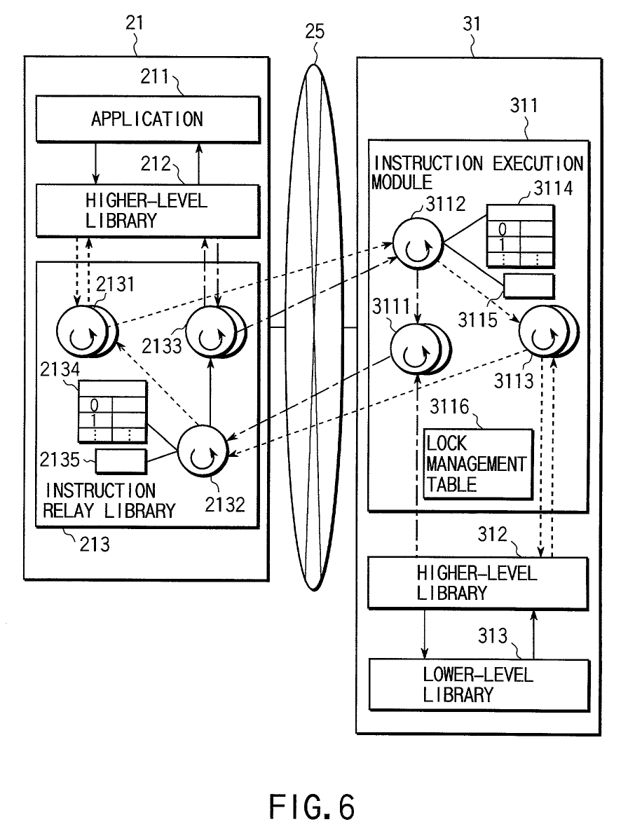

FIG. 6 is a diagram showing an automatic distributed processing system for avoiding deadlock shown in FIG. 5 according to the second embodiment of the present invention. As shown in FIG. 6, the instruction execution module 311 has a lock management table 3116 in this embodiment. The lock management table 3116 is comprised of a lock identifier 31161 and a thread identifier 31163 indicating a thread which holds a lock.

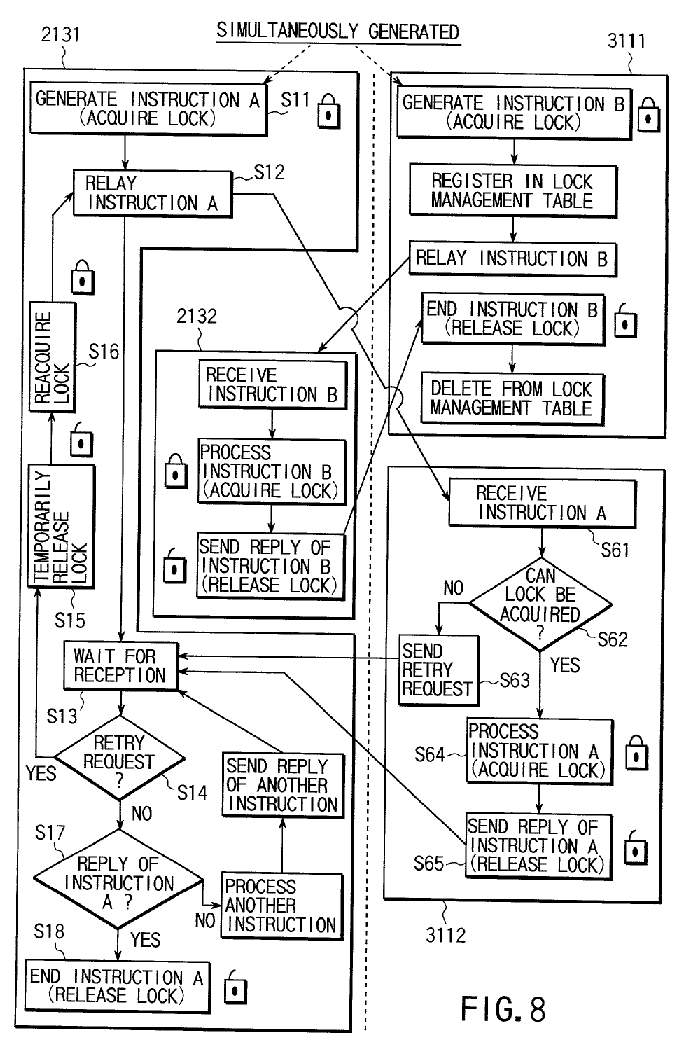

The operation of the second embodiment with the above arrangement will be described below with reference to FIG. 8. In this embodiment as well, the server machine 21 entrusts to the client machine 31 an instruction appended with a thread identifier explained in the first embodiment. In this embodiment, two locks which are present at the same time are discriminated to be a main lock and a sub lock (auxiliary lock). The main lock is an absolute one and has higher priority than the sub lock, and the sub lock is an auxiliary one. When the main lock is acquired, that lock is registered in the lock management table 3116. A thread that acquires the sub lock looks up the lock management table 3116, and when it confirms that the main lock is already held by another thread, that thread informs the thread which holds the main lock of a message indicating that it cannot acquire a lock, and releases its lock.

Assume that the instruction relay thread (user thread) 2131 acquires a sub lock upon generation of instruction A and relays instruction A to the instruction processing thread 3112, and the instruction relay thread (event processing thread) 3111 acquires a main lock in response to generation of instruction B and relays instruction B to the instruction processing thread 2132. The instruction processing thread 2132 attempts to acquire a sub lock to process instruction. But since the sub lock already held by the instruction relay thread (user thread) 2131, the thread 2132 temporarily sets itself in a wait sate until the instruction relay thread (user thread) 2131 releases the sub lock. As a result, since the instruction processing thread 3112 becomes ready to process instruction A, it receives instruction A (S61), and checks if a main lock can be acquired (S62). In this case, since the main lock is already held by the instruction relay thread (event processing thread) 3111, the thread 3112 determines that the lock cannot be acquired, and sends a retry request to the instruction relay thread (user thread) 2131 (S63).

The instruction relay thread (user thread) 2131 receives the retry request (S13), and checks if the retry request is received (S14). If YES in step S14, the thread 2131 temporarily releases the sub lock (S15). In this way, the instruction processing thread 2132 acquires the sub lock, processes instruction B, returns the processing result to the instruction relay thread (event processing thread) 3111, and releases the sub lock. Upon receiving the processing result of instruction B, the instruction relay thread (event processing thread) 3111 deletes the main lock registered in the lock management table 3116. After that, the instruction relay thread (user thread) 2131 acquires the sub lock again (S16). The thread 2131 then retries. That is, the thread 2131 relays instruction A to the instruction processing thread 3112 again. As a result, the instruction processing thread 3112 determines in step S62 that the main lock can be acquired, processes instruction A (S64), and returns the processing result of instruction A to the instruction relay thread (user thread) 2131. Consequently, the instruction relay thread (user thread) 2131 determines in step S17 that a reply of the instruction A is received, ends instruction A, and releases the sub lock (S18).

Therefore, according to the aforementioned embodiment, when the client machine 31 receives an instruction from the server machine 21, it checks if it can acquire a lock for itself. If a lock cannot be acquired, the client machine 21 sends a retry request to the server machine 21, and prompts the server machine 21 to relay the instruction again, thus easily avoiding deadlock.

In general, as a means for avoiding deadlock, an exclusive lock may be unconditionally released upon relaying the first instruction. However, since such instruction is executed by the application which holds an exclusive lock, if the exclusive lock is inadvertently released, the exclusive function does not work, and unexpected lock conflict may occur.

This system makes the best use of the exclusive function on the server machine 21, and avoids deadlock only when there is a risk of deadlock.

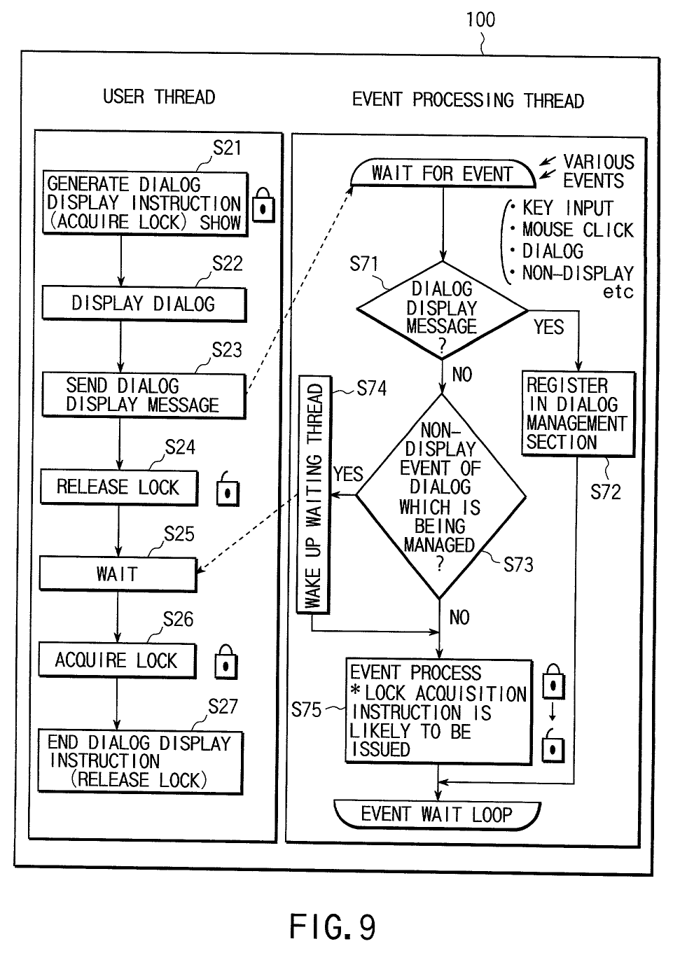

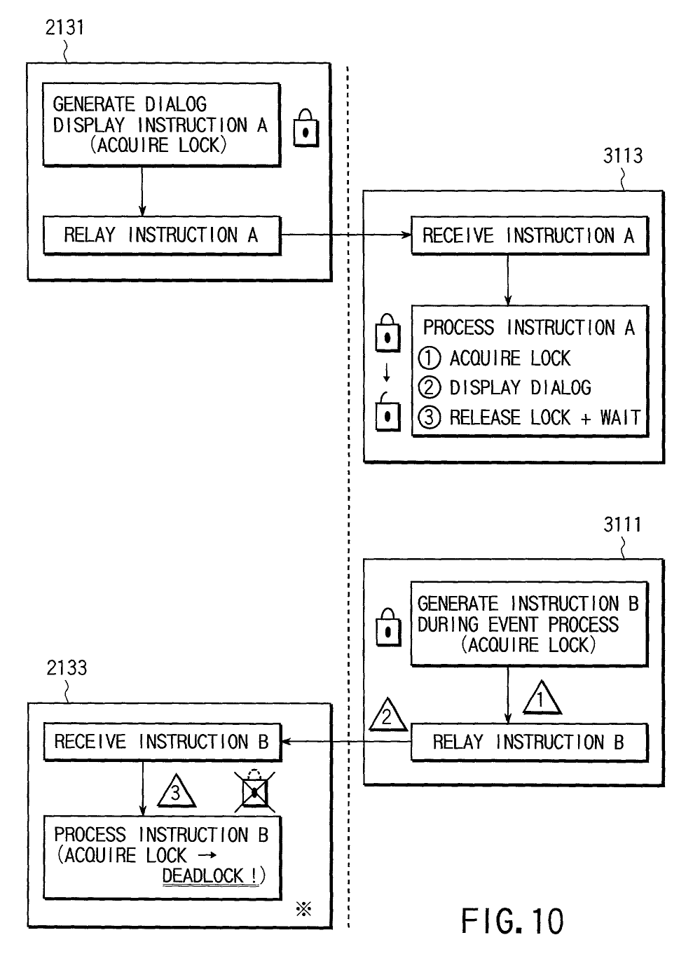

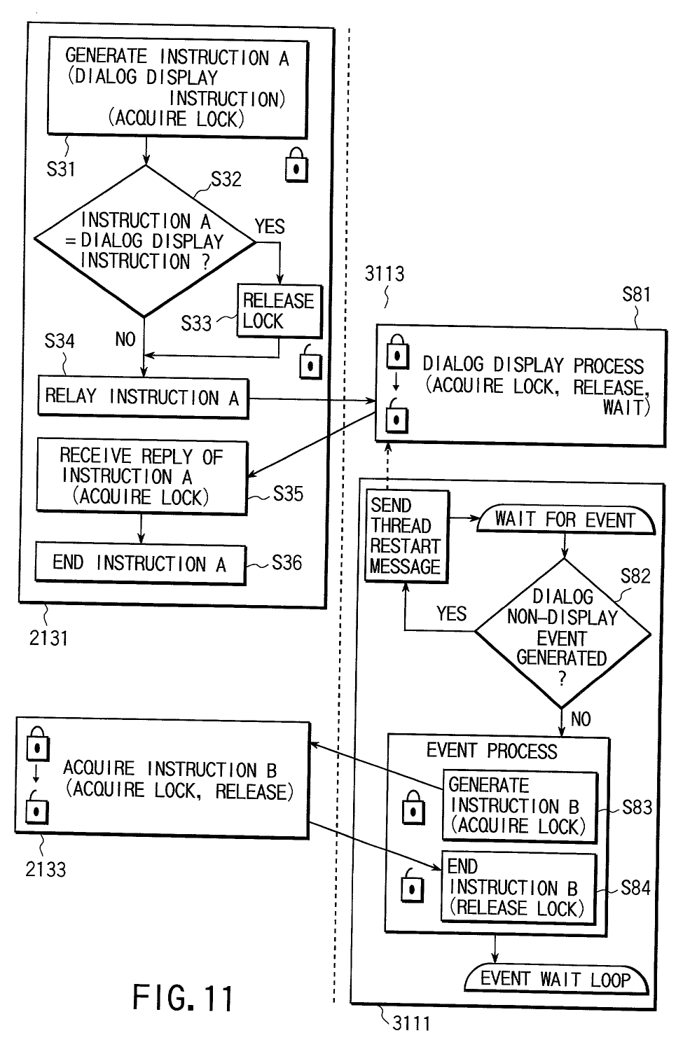

The third example of the deadlock generation mechanism will be explained below using FIGS. 9 and 10. Note that the methods in the first and second embodiments are implemented in this case.

In this example, when an icon is clicked by, e.g., a mouse on a processing window in a given machine, i.e., in the server machine 21 or client machine 31 to issue a dialog display instruction, a dialog box (event generation thread) is generated in response to the mouse event, and the thread is set in a wait state until that dialog box is closed, deadlock occurs.

In normal execution operation of the execution machine 100 upon displaying an input event wait dialog, as shown in FIG. 9, if a dialog display instruction is generated (S21), an exclusive lock is acquired. After the dialog is displayed (S22), a dialog display message is sent to the event processing thread (S23).

Upon receiving the dialog display message, the event processing thread determines the presence of the dialog display message (S71), and registers the message in a dialog manager (S72). The thread then returns to an event wait loop.

On the other hand, after the dialog display message is output (S23), the user thread releases the lock (S24), and enters a wait state (S25). This wait state continues until the thread is waken up by another thread. For example, this wait state continues while a help window is displayed. When an OK button is pressed and the help window is closed, the thread is waken up, and can proceed with the processing. When the help window is closed, a close event (dialog non-display event) is generated, and is sent to the event processing thread. In response to this event, YES is determined in step S73, and the waiting thread is waken up (S74). If no dialog non-display event is generated, a lock is acquired to execute an event process, and is released upon completion of the processing (S75).

Upon entering the dialog non-display event in step S74, the waiting thread is restarted, and a lock is acquired (S26).

Therefore, upon normal execution on a single machine, since a lock is acquired and released while checking each other's threads, deadlock is unlikely to occur.

However, when the automatic distributed processing system according to the present invention is applied to the aforementioned dialog display technique, deadlock takes place, as shown in FIG. 10. That is, during processing of the server application in the server machine 21, the instruction relay thread 2131 acquires a lock after it generates dialog display instruction A, sends instruction A to the instruction processing thread 3113 of the client machine 31, and waits for completion of the instruction process.

Meanwhile, the instruction processing thread 3113 of the client machine 31 receives and processes instruction A. That is, the thread 3113 acquires a lock, displays a dialog, releases the lock, and then stands by.

However, the instruction relay thread (user thread) 2131 retains its lock. In this state, if instruction B that requires to acquire a lock during an event process is generated, the instruction relay thread 3111 of the client machine 31 relays instruction B to the instruction processing thread 2133 of the server machine 21. The instruction processing thread 2133 receives instruction B and attempts to acquire a lock. However, since the instruction relay thread (user thread) 2131 holds a lock, the thread 2133 cannot acquire a lock. For this reason, deadlock occurs. That is, the event processing thread 3111 on the client machine 31 cannot wake up the wait state of the instruction processing thread 3113 since it does not receive any reply from the instruction processing thread 2133. As a consequence, deadlock takes place.

In the system of the present invention, upon generation of instruction A (dialog display instruction) (S31), the instruction relay thread 2131 of the server machine 21 acquires a lock. However, if this instruction A is a dialog display instruction (S32), the thread 2131 releases the lock (S33) and relays instruction A to the instruction processing thread 3113 of the client machine 31 (S34). Steps S31 to S33 define an instruction analysis/lock release function.

Upon receiving instruction A, the instruction processing thread 3113 of the client machine 31 acquires a lock to process dialog display as the instruction contents (in the process, the thread 3113 releases the lock and waits for a restart request (see (1), (2), and (3) in FIG. 10). Upon completion of the process, the thread 3113 sends a reply (S81). The instruction relay thread 2131 of the server machine 21 receives the reply from the client machine 31 (S35) and ends instruction A (S36).

On the other hand, the instruction relay thread 3111 of the client machine 31 checks the presence/absence of generation of a dialog non-display event at predetermined time intervals (S82). Upon generating the dialog non-display event, the thread 3111 executes an event process (acquire a lock). Upon generating instruction B (S83), the thread 3111 sends instruction B to the instruction processing thread 2133 of the entrust source machine 21. Upon receiving a reply after the instruction process, the thread 3111 ends instruction B (S84), and releases the lock.

Therefore, according to the aforementioned embodiment, the instruction relay thread 2131 of the server machine 21 acquires a lock upon generation of instruction A. However, when a dialog display instruction is generated, i.e., when an instruction which must wait for the processing result on the client side is issued, the thread 2131 releases the lock, and relays the instruction to the client machine 31. Therefore, since the event processing thread 311 of the client machine 31 generates new instruction B during the event process and the lock of the server machine 21 is released, the server machine 21 can easily avoid deadlock even when instruction B is generated.

In the first embodiment described above, the server 21 has an instruction relay library which is compatible with the lower-level library, and upon generation of an instruction, the instruction relay thread 2131 of the server 21 appends a thread identifier to the instruction and relays that instruction to the instruction distribution thread 3112 of the client 31. Alternatively, the client 31 may have an instruction relay library which has the same arrangement as that of the instruction relay library 2132, and upon generation of an instruction, the instruction relay thread 311 may append a thread identifier of the client side to that instruction, and may relay the instruction to the instruction distribution thread of the server.

In the aforementioned embodiment, the client machine 31 acquires a main lock, the server 21 acquires a sub lock, and the client 31 has the lock management table 3116. Alternatively, the lock acquired by the server 21 may be a main lock, the lock acquired by the client 31 may be a sub lock, and the server 21 may have the lock management table 3116.

Note that the present invention is not limited to the above specific embodiments, and various modifications of the invention may be made without departing from the scope of the invention. The respective embodiments can be implemented in combination as long as they can be combined. In such case, such combinations can provide another effect. Furthermore, each embodiment includes various higher-level and specific inventions, and various inventions can be expected by appropriately combining a plurality of disclosed building components. For example, when an invention is extracted by omitting some building components from all the ones of a given embodiment, the omitted components are appropriately compensated for by a technique upon implementing the extracted invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An automatic distributed processing system comprising:
a server machine including:
an instruction relay library comprising:
a thread management table for storing thread identifiers in correspondence with threads;
a server instruction relay thread for, when an instruction is generated during processing of an application, appending a thread identifier managed by said thread management table to the instruction, and sending the instruction to a client machine in collaboration with a higher-level library of said server machine; and
a server instruction distribution thread for distributing a thread which processes another instruction from the client machine; and
a client machine connected to said server machine via a network, said client machine including:
an instruction execution module comprising:
a client instruction distribution thread for receiving the instruction sent from said instruction relay thread of said server machine together with the thread identifier, creating a thread that processes the instruction, and passing the received instruction to the created thread together with the thread identifier; and
an instruction processing thread for processing the received instruction in collaboration with a higher-level library of said client machine, and for, when another instruction is generated upon processing the received instruction or the processing of the received instruction is complete, sending the other instruction or a processing end reply appended with the thread identifier to said instruction distribution thread of said server machine.

2. A computer program product that records a program for operating a server machine that entrusts a process of an instruction to a client machine in an automatic distributed processing system,
said program comprising:
computer readable program code means for making the server machine implement an instruction relay function of appending a thread identifier to an instruction generated during processing of an application of the server machine by looking up a table that manages a relationship between thread identifiers and threads, and sending the instruction to the client machine;
computer readable program code means for making the server machine implement an instruction distribution function of distributing another instruction which is generated upon an instruction process of the client machine and is appended with the thread identifier to a thread as an entrust source; and
computer readable program code means for making the server machine implement a function of returning a processing result of the other instruction which is distributed to and processed by the thread of the server machine to the client machine.

3. A computer program product that records a program for operating a client machine to which a server machine entrusts an instruction in an automatic distributed processing system,
said program comprising:
computer readable program code means for making the client machine implement a thread creation function of creating a thread that processes an instruction received from the server machine together with a thread identifier, on the basis of the thread identifier; and
computer readable program code means for making the client machine implement a function of sending another instruction which is generated while the thread created by the thread creation function processes the instruction to the server machine while appending the received thread identifier to the other instruction.

4. An automatic distributed processing system in which a server machine and client machine are connected via a network,
wherein each of the server and client machines comprises an instruction relay thread for, when an instruction is generated upon processing of a self application after an exclusive lock, acquiring a lock and relaying the instruction to a partner machine, and an instruction processing thread for receiving and processing the instruction from said instruction relay thread,
at least said instruction processing thread of the client machine comprises means for receiving the instruction from the server machine, checking if a self machine can acquire a lock, and sending a retry request to the server machine if the lock cannot be acquired, and means for acquiring the lock if the lock can be acquired, and sending a reply upon completion of processing of the instruction, and releasing the lock, and
at least said instruction relay thread of the server machine comprises means for making a retry that temporarily releases the lock, then reacquires the lock, and relays the instruction again upon receiving the retry request from the client machine, and means for releasing the lock upon receiving the reply indicating end of the instruction from the server machine.

5. A computer program product that records a program for operating a server machine that entrusts a an instruction in an automatic distributed processing system,
said program comprising:
computer readable program code means for making the server machine implement an instruction relay function of relaying an instruction, which is generated during processing of a self application after an exclusive lock, to an instruction processing thread of the server machine, and setting itself in a reception wait state;
computer readable program code means for making the server machine implement an instruction relay retry function of making a retry that temporarily releases the lock, then reacquires the lock, and relays the instruction again upon receiving a retry request from an instruction processing thread of the client machine during processing of the instruction; and
computer readable program code means for making the server machine implement an instruction processing end function of releasing the lock and ending the instruction upon receiving an instruction end reply from the instruction processing thread of the client machine.

6. A computer program product that records a program for operating a client machine to which a server machine entrusts an instruction in an automatic distributed processing system,
said program comprising:
computer readable program code means for making the client machine implement a lock acquisition checking function of checking if a self machine can acquire a lock, after an instruction is received from the server machine;
computer readable program code means for making the client machine implement a retry request function of sending a retry request to the server machine when the checking function determines that the lock cannot be acquired; and
computer readable program code means for making the client machine implement an instruction processing function of acquiring an exclusive lock and processing the received function when the checking function determines that the lock can be acquired, sending a reply to the server machine upon completion of the processing of the instruction, and releasing the lock.

7. An automatic distributed processing system in which a server machine and a client machine having an event processing function are connected via a network,
wherein the server machine comprises: an instruction relay thread which has means for, when a first instruction is generated during processing of an application after an exclusive lock, releasing the lock in correspondence with contents of the instruction, and sending the first instruction to an instruction processing thread of the client machine, and means for ending the first instruction upon receiving an end reply of the instruction process in the instruction processing thread; and an instruction processing thread for processing a second instruction sent from an event processing thread of the client machine, and
said client machine comprises: an instruction processing thread of the client machine for, when the first instruction is received from said instruction relay thread, acquiring an exclusive lock, processing the first instruction, releasing the lock, waiting until a restart request is received from the event processing thread, releasing the lock upon completion of the instruction process after the restart, entrusting the end of the instruction process to said instruction relay thread, and sending a restart request to the client machine which is in the wait state; and an event processing thread of the client machine for, when a second instruction is generated during a self event process after an exclusive lock, entrusting the second instruction to said instruction processing thread of the server machine.

8. A computer program product that records a program for operating a server machine that entrusts a an instruction in an automatic distributed processing system,
said program comprising:
computer readable program code means for, when a first instruction is generated during processing of an application after an exclusive lock, making the server machine release the lock in correspondence with contents of the instruction, and send the first instruction to an instruction processing thread of the client machine;
computer readable program code means for making the server machine end the first instruction upon receiving an end reply of the instruction process in the instruction processing thread; and
computer readable program code means for making the server machine process a second instruction sent from an event processing thread of the client machine.

9. A computer program product that records a program for operating a client machine to which a server machine entrusts an instruction in an automatic distributed processing system in which the server and client machines are connected via a network,
said program comprising:
computer readable program code means for, when a first instruction is received from the server machine, making the client machine acquire an exclusive lock and process the first instruction, release the lock, wait until a restart request is received from the event processing thread, release the lock upon completion of the instruction process after the restart, entrust the end of the instruction to the server machine, and send a restart request to the client machine which is in the wait state; and
computer readable program code means for, when a second instruction is generated during a self event process after an exclusive lock, making the client machine entrust the second instruction to the server machine.
